(19) United States
(12) Patent Application Publication
(10) Pub. No.: US 2013/0313129 A1
(43) Pub. Date: Nov. 28, 2013

(54) METHOD FOR MEASURING TOTAL CONCENTRATION OF OXIDIZING AGENTS, CONCENTRATION METER FOR MEASURING TOTAL CONCENTRATION OF OXIDIZING AGENTS, AND SULFURIC ACID ELECTROLYSIS DEVICE EQUIPPED WITH SAME

(71) Applicants: Junko Kosaka, Tamano-shi (JP); Masaaki Kato, Tamano-shi (JP); Hiroki Domon, Tamano-shi (JP)

(72) Inventors: Junko Kosaka, Tamano-shi (JP); Masaaki Kato, Tamano-shi (JP); Hiroki Domon, Tamano-shi (JP)

(73) Assignee: CHLORINE ENGINEERS CORP., LTD., Tokyo (JP)

(21) Appl. No.: 13/984,451

(22) PCT Filed: Feb. 27, 2012
(86) PCT No.: PCT/JP2012/054809

§ 371 Date: Aug. 8, 2013

(30) Foreign Application Priority Data
Mar. 3, 2011 (JP) 2011-046625

(51) Int. Cl. G01N 27/26; G01N 21/17; G01N 9/36; G01N 29/02

(52) U.S. Cl. CPC G01N 27/26; G01N 29/02; G01N 21/17; G01N 9/36
USPC 205/786; 205/782; 204/400; 73/61.41; 250/372

(57) ABSTRACT

Provided are: a method of measuring the total concentration of oxidizing agents, by which the total concentration can be determined in a single measurement with simple operations even in an evaluation solution containing multiple components such as persulfuric acid, perosulfate and hydrogen peroxide; a simple and inexpensive concentration meter for measuring the total concentration of oxidizing agents; and a sulfuric acid electrolysis device comprising the concentration meter.

The method according to the present invention is a method of measuring the total concentration of oxidizing agent(s) in an evaluation solution containing at least one oxidizing agent. The method comprises at least the steps of: heat-treating the evaluation solution at 50 to 135° C.; and detecting hydrogen peroxide in the thus heat-treated evaluation solution.

### TECHNICAL FIELD

The present invention relates to a method of measuring the total concentration of oxidizing agents and a concentration meter for measuring the total concentration of oxidizing agents (hereinafter, may also be simply referred to as “the measurement method” and “the concentration meter”, respectively) as well as a sulfuric acid electrolysis device comprising the concentration meter.

### BACKGROUND ART

Persulfuric acid, which is a general term for peroxodisulfuric acid and peroxomonosulfuric acid, and hydrogen peroxide have excellent oxidizing power. Therefore, a mixed solution of sulfuric acid and an aqueous hydrogen peroxide solution and a solution which is obtained by oxidizing sulfuric acid by direct electrolysis and incorporating persulfuric acid and/or hydrogen peroxide in the resultant are utilized as an agent in a variety of production processes and testing processes, such as a pretreatment agent or etching agent for metal electrolytic plating, an oxidizing agent for chemical and mechanical grinding treatment in the production of a semiconductor device, an oxidizing agent of an organic substance in wet analysis or a washing agent of a silicon wafer.

In the present invention, the term “oxidizing agent” means, for example, persulfuric acid, which is a general term for peroxodisulfuric acid and peroxomonosulfuric acid, or hydrogen peroxide. In addition, in the present invention, the term “SPM” means a mixed solution of sulfuric acid and an aqueous hydrogen peroxide solution.

Further, in the present invention, the term “sulfuric acid electrolysis device” means a device for producing a solution containing persulfuric acid and/or hydrogen peroxide by oxidation of sulfuric acid through direct electrolysis. Moreover, in the present invention, the term “electrolyzed sulfuric acid solution” means a solution prepared by oxidizing sulfuric acid through direct electrolysis and thereby incorporating persulfuric acid and/or hydrogen peroxide in the resultant.

Furthermore, in the present invention, the term “concentration meter for measuring the total concentration of oxidizing agents” means a concentration meter which measures the total concentration of oxidizing agent(s) in a solution containing at least one oxidizing agent. Here, regardless of whether the solution contains a single or multiple oxidizing agents, the concentration meter indicates a measurement result in terms of total concentration thereof.

In cases where an oxidizing agent is used for washing, surface treatment or the like of a member, the treatment effect is variable depending on the concentration of peroxodisulfuric acid, peroxomonosulfuric acid, hydrogen peroxide or the like; therefore, in order to attain a desired treatment effect, it is required to monitor the concentration of each oxidizing agent in the SPM or electrolyzed sulfuric acid solution. However, monitoring of the concentrations of multiple components individually requires a complex and expensive instrument; therefore, it is thought to monitor the total concentration of all components instead.

As a prior art relating to an oxidizing agent, for example, Patent Document 1 discloses a method of synthesizing hydrogen peroxide in which peroxodisulfuric acid is generated by electrolysis of sulfuric acid and then converted to hydrogen peroxide and sulfuric acid by hydrolysis. However, Patent Document 1 discloses only a solution containing peroxodisulfuric acid and does not offer any description with regard to a solution containing multiple components of oxidizing agents. In addition, Patent Document 1 offers neither a description on the relationship between temperature and time relating to the treatments nor a description on a concentration measurement method utilizing the technology.

Further, Patent Document 2 discloses a method of determining the total concentration of oxidizing agents by adding an aqueous potassium iodide solution to a sample solution containing the oxidizing agents and then titrating iodine released by a reaction between the aqueous potassium iodide solution and the oxidizable components with a sodium thiosulfate solution. However, the quantification method according to Patent Document 2 requires a worker to perform the titration. In addition, in cases where a fully-automatic titrator is used to overcome the need for a worker, for example, operations of measuring and injecting the sample solution, adding a diluent and aqueous potassium iodide solution to the sample solution and performing titration with a sodium thiosulfate solution are required, making the measurement and quantification operations complex. Moreover, there is also a drawback that the equipment is expensive due to its complex structure. Furthermore, since the waste liquid discharged after the measurement contains potassium iodide and sodium thiosulfate, it is required to separately perform an operation of treating the waste liquid.

Further, Non-patent Document 1 discloses a method of qualitatively and quantitatively measuring peroxodisulfuric acid, peroxomonosulfuric acid and hydrogen peroxide in a sulfuric acid solution by the use of laser Raman spectra. However, in the qualitative and quantitative measurement method using laser Raman spectra according to Non-patent Document 1, since the components are qualitatively and quantitatively measured individually, it is required to measure the intensity for each wave number of the respective components and to calculate the concentration with conversion based on the calibration curve of each component, which makes the measurement and quantification operations complex. In addition, there is also a drawback that the equipment is expensive due to its complex structure.

### RELATED ART DOCUMENTS

### Patent Documents

Patent Document 1: Japanese Unexamined Patent Application Publication (Translation of PCT Application) No. 2008-514541
Patent Document 2: Japanese Unexamined Patent Application Publication No. 2008-164504

### Non-Patent Document

Non-patent Document 1: Akimasa Tasaka, Electrochemistry, 9, 745 (1998)

### SUMMARY OF THE INVENTION

### Problems to be Solved by the Invention

As described in the above, in the prior art, the total concentration of multiple oxidizing agents could not be determined at once with simple operations. In addition, conventional concentration meters have complex structures and are expensive; therefore, there is a demand for a simpler and inexpensive concentration meter.

In view of the above, objects of the present invention are: to provide a method of measuring the total concentration of oxidizing agents, by which the above-described problems in the prior art are solved and the total concentration can be determined in a single measurement with simple operations even in an evaluation solution containing multiple components such as persulfuric acid, perosulfate and hydrogen peroxide; a simple and inexpensive concentration meter for measuring the total concentration of oxidizing agents; and a sulfuric acid electrolysis device comprising the concentration meter.

### Means for Solving the Problems

The present inventors intensively studied to solve the above-described problems and discovered that, by subjecting an evaluation solution containing oxidizing agents to a heat treatment, the oxidizing agents can be converted to hydrogen peroxide and that the total concentration of the oxidizing agents can be determined at once by measuring the concentration of the resulting hydrogen peroxide, thereby solving the above-described problems.

That is, the method of measuring the total concentration of oxidizing agents according to the present invention is a method of measuring the total concentration of oxidizing agent(s) in an evaluation solution containing at least one oxidizing agent, the method being characterized by comprising at least the steps of:

heat-treating the above-described evaluation solution at 50 to 135° C. (heat treatment step); and detecting hydrogen peroxide in the thus heat-treated evaluation solution (hydrogen peroxide detection step).

In the measurement method of the present invention, it is preferred that the above-described evaluation solution contain, as the above-described oxidizing agent, at least one of peroxodisulfate ion, peroxomonosulfate ion and hydrogen peroxide. Further, it is preferred that the above-described evaluation solution have an acid concentration of 6 to 24 mol/l and that the heat treatment in the above-described heat treatment step be performed for 2 to 70 minutes after the temperature of the above-described evaluation solution reached a prescribed temperature.

Moreover, in the above-described hydrogen peroxide detection step, hydrogen peroxide can be detected by using any one selected from absorbance, electrochemical process, ultrasonic wave, density and refractive index. Particularly, it is preferred that the detection of hydrogen peroxide in the above-described hydrogen peroxide detection step be performed by measuring the absorbance at a wavelength of 220 to 290 nm or by an electrochemical process using a carbon material or platinum as a working electrode. It is also preferred that the detection of hydrogen peroxide in the above-described hydrogen peroxide detection step be performed by using the above-described electrochemical process and that, in the electrochemical process, the working electrode be retained at an electric potential at which electrolysis reaction of water does not proceed and only oxidation or reduction reaction of hydrogen peroxide proceeds.

The concentration meter for measuring the total concentration of oxidizing agents according to the present invention is a concentration meter used to measure the total concentration of oxidizing agent(s) in an evaluation solution containing at least one oxidizing agent, the concentration meter being characterized by comprising:

a storage section where the above-described evaluation solution is stored; a heat treatment section where the evaluation solution in the storage section is heated to a prescribed temperature; and a hydrogen peroxide detecting section where hydrogen peroxide in the thus heat-treated evaluation solution is detected.

In the concentration meter of the present invention, it is preferred that the above-described hydrogen peroxide detecting section comprise any one selected from an absorbance meter, an electrochemical measuring instrument, an ultrasonic meter, a densimeter and a refractometer. Further, it is also preferred that the above-described hydrogen peroxide detecting section comprise an absorbance meter equipped with a light source having an emission wavelength of 220 to 290 nm and/or an electrochemical measuring instrument in which a carbon material or platinum is used as a working electrode. Moreover, it is also preferred that the above-described hydrogen peroxide detecting section comprise the above-described electrochemical measuring instrument and that the working electrode used therein be retained at an electric potential at which electrolysis reaction of water does not proceed and only oxidation or reduction reaction of hydrogen peroxide proceeds.

Further, the sulfuric acid electrolysis device of the present invention is characterized by comprising the above-described concentration meter for measuring the total concentration of oxidizing agents according to the present invention.

### Effects of the Invention

According to the present invention, the followings can be realized: a method of measuring the total concentration of oxidizing agents by which, even in an evaluation solution containing multiple components of oxidizing agents such as peroxodisulfate ion, peroxomonosulfate ion and hydrogen peroxide, the total concentration thereof can be determined in a single measurement with simple operations; a simple and inexpensive concentration meter for measuring the total concentration of oxidizing agents; and a sulfuric acid electrolysis device comprising the concentration meter.

In the measurement method of the present invention, regardless of whether the evaluation solution contains a single or multiple oxidizing agents, the total concentration thereof can be determined. Further, the concentration meter of the present invention is suitable for both general household and commercial applications since it is capable of measuring the total concentration of multiple components at once and the constituent instruments required for the measurement can thus be reduced in number and made smaller and less expensive.

### BRIEF DESCRIPTION OF THE DRAWINGS

FIG. 1 is a flow diagram showing one example of the method of measuring the total concentration of oxidizing agents according to the present invention.

FIG. 2 is a flow diagram showing another example of the method of measuring the total concentration of oxidizing agents according to the present invention.

FIG. 3 is a flow diagram showing yet another example of the method of measuring the total concentration of oxidizing agents according to the present invention.

### MODE FOR CARRYING OUT THE INVENTION

The modes for carrying out the present invention will now be described in detail.

The present invention relates to an improvement of a method for measuring the total concentration of oxidizing agent(s) in an evaluation solution containing at least one oxidizing agent. In the present invention, it was discovered that a property of quantifying the oxidizing agent concentration can be attained by heat-treating such an evaluation solution at 50 to 135° C. (heat treatment step) and then detecting hydrogen peroxide in the thus heat-treated evaluation solution (hydrogen peroxide detection step).

More specifically, in the present invention, an evaluation solution is heat-treated under the above-described temperature condition and then cooled, followed by detection of hydrogen peroxide. After the evaluation solution is prepared, it may be stored in an evaluation solution tank from which a prescribed amount of the evaluation solution can be taken out and subjected to measurement.

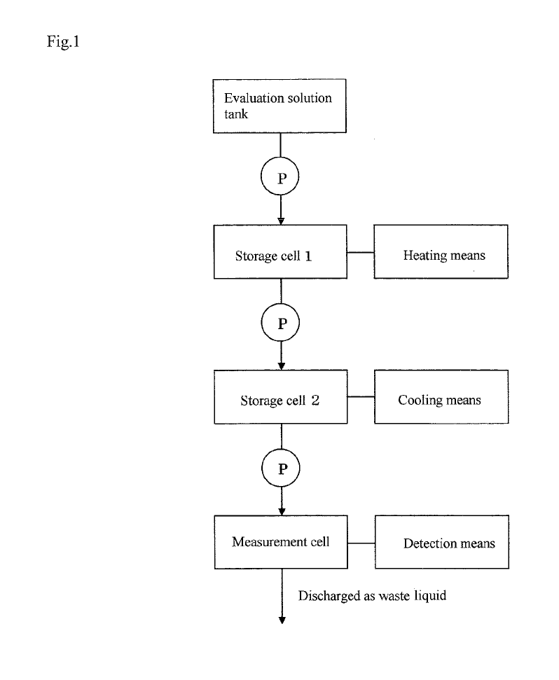

The measurement can be carried out by, for example, as shown in the flow diagram of FIG. 1, in a system where storage cells 1 and 2 and a measurement cell are sequentially connected via pumps to an evaluation solution tank, heat-treating an evaluation solution discharged from the evaluation solution tank by a heating means in the storage cell 1, cooling the resulting evaluation solution by a cooling means in the storage cell 2 and then detecting hydrogen peroxide by a detection means in the measurement cell.

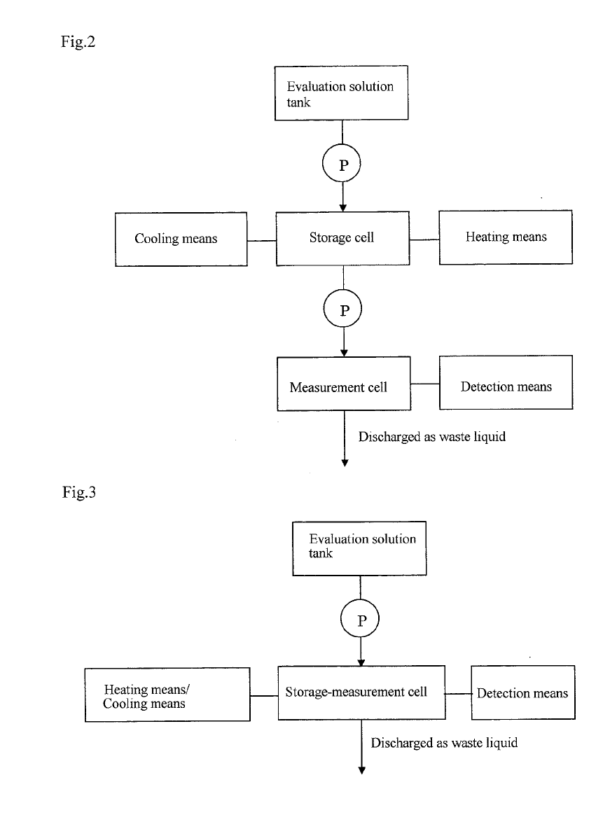

Alternatively, as shown in the flow diagram of FIG. 2, the measurement can also be carried out by, in a system where a storage cell and a measurement cell are sequentially connected via pumps to an evaluation solution tank, after heat-treating an evaluation solution discharged from the evaluation solution tank by a heating means and cooling the evaluation solution by a cooling means in the storage cell, detecting hydrogen peroxide by a detection means in the measurement cell.

Further, as shown in the flow diagram of FIG. 3, the measurement can also be carried out by, in a storage-measurement cell connected to an evaluation solution tank via a pump, heat-treating an evaluation solution discharged from the evaluation solution tank by a heating means, cooling the resulting evaluation solution by a cooling means and then detecting hydrogen peroxide by a detection means.

In the present invention, there is no restriction on the presence or absence of cooling of the evaluation solution at the time of the measurement and the evaluation solution can be measured even in a heated state; however, in cases where the volume or the like of the evaluation solution is altered by heating, it is preferred to perform temperature correction.

In the present invention, the evaluation solution may contain, as oxidizing agent, at least one of peroxodisulfate ion, peroxomonosulfate ion and hydrogen peroxide. In the present invention, peroxodisulfuric acid, peroxomonosulfuric acid and hydrogen peroxide may each be in the form of an aqueous solution, a dissolved salt or the like thereof, or may be one which is prepared by mixing of sulfuric acid and an aqueous hydrogen peroxide solution or by electrolysis of sulfuric acid.

The self-decomposition reactions of the oxidizing agents are shown below.

H₂S₂O₈+H₂O→H₂SO₅+H₂SO₄ (1)

H₂SO₅+H₂O→H₂O₂+H₂SO₄ (2)

Peroxodisulfuric acid and peroxomonosulfuric acid are decomposed with time and eventually converted into hydrogen peroxide. Here, a heat treatment of these acids can make the reactions to proceed quickly. Further, as apparent from the above-described Formulae (1) and (2), since the concentration of hydrogen peroxide generated from the self-decomposition reactions is the same as that of unreacted peroxodisulfuric acid and peroxomonosulfuric acid, the concentration of hydrogen peroxide generated by the reactions of the above-described Formulae (1) and (2) represents the total concentration of the oxidizing agents prior to the self-decomposition.

In the present invention, the temperature of the heat treatment is required to be 50 to 135° C., preferably 90 to 125° C. When the heat treatment temperature is lower than 50° C., the reactions of the above-described Formulae (1) and (2) proceed slowly. The upper limit of the heat treatment temperature varies depending on the boiling point of each evaluation solution; however, when the heat treatment temperature is higher than 135° C., since the reaction of the following Formula (3) also quickly proceeds in addition to the above-described reactions of the Formulae (1) and (2) and the oxidizing agents are consequently eliminated, the total concentration of the oxidizing agents is reduced and thus cannot be measured accurately.

H₂O₂→½O₂+H₂O (3)

In the present invention, the evaluation solution containing at least one oxidizing agent has an acid concentration of preferably 6 to 24 mol/l, more preferably 7 to 18 mol/l. This value was obtained based on a discovery that the conversions of peroxodisulfuric acid and peroxomonosulfuric acid into hydrogen peroxide and the elimination rate of the oxidizing agents, which are represented by the above-described Formulae (1), (2) and (3), are closely related to the acid concentration of the evaluation solution. In this acid concentration range, since the reactions of the above-described Formulae (1) and (2) easily proceed, the effect of converting the oxidizing agents into hydrogen peroxide by the heat treatment is high. When the acid concentration is less than 6 mol/l, the reactions of the above-described Formulae (1) and (2) are not likely to proceed. Although the conversion rate into hydrogen peroxide can be increased by extending the heat treatment time, this also extends the time required for the measurement, which is not preferred for a measurement method and a concentration meter. Meanwhile, when the acid concentration is higher than 24 mol/l, since the reaction of the above-described Formula (2) is not likely to proceed while the reaction of the above-described Formula (3) easily proceeds, the total concentration of the oxidizing agents cannot be measured accurately.

This also means that, in a solution having an acid concentration of 6 to 24 mol/l, peroxodisulfuric acid, peroxomonosulfuric acid and hydrogen peroxide are likely to coexist because the reactions of the above-described Formulae (1) and (2) easily proceed. For example, when sodium peroxodisulfate is dissolved in water, it mainly exists in the form of peroxodisulfate ion in the resulting solution. In this case, since only one component is to be detected, its concentration can be quantified by an arbitrary method such as an absorbance meter, an electrochemical measuring instrument, an ultrasonic meter, a densimeter or a refractometer, even without heat treatment. Meanwhile, when sodium peroxodisulfate is dissolved in a solution having an acid concentration of 6 to 24 mol/l, the reactions of the above-described Formulae (1) and (2) proceed in the resulting solution. As a result, the solution is likely to be in a condition where peroxodisulfuric acid, peroxomonosulfuric acid and hydrogen peroxide coexist. In such a condition, the ratios of the respective components are variable depending on the solution temperature, the time elapsed after the dissolution and the concentrations of the respective components. In this case, since multiple components are to be measured, it is required that the evaluation be performed using a measuring apparatus (e.g., Raman spectrometer) which is capable of qualitatively and quantitatively measure each component. However, even in the case of a solution containing multiple components as measurement subjects, by subjecting the solution to the heat treatment according to the present invention and thereby accelerating the reactions of the above-described Formulae (1) and (2) to increase the ratio of hydrogen peroxide, a quantitative property can be attained by an arbitrary means, such as an absorbance meter, an electrochemical measuring instrument, an ultrasonic meter, a densimeter or a refractometer. This means that the present invention can also be effectively applied to a solution having an acid concentration of 6 to 24 mol/l, which is conventionally difficult to be quantified. Therefore, the present invention is particularly useful when the evaluation solution has an acid concentration of 6 to 24 mol/l.

In the present invention, the heat treatment time in the heat treatment step is preferably 2 to 70 minutes, more preferably 2 to 50 minutes, after the temperature of the evaluation solution reached a prescribed temperature. When the heat treatment time is shorter than 2 minutes, the reactions of the above-described Formulae (1) and (2) do not proceed sufficiently, so that the conversion rate into hydrogen peroxide is reduced and quantitative property thus cannot be attained. Meanwhile, when the heat treatment is performed for a period of longer than 70 minutes, since the reaction of the above-described Formula (3) proceeds to reduce the concentration of hydrogen peroxide, the total concentration of the oxidizing agents cannot be measured accurately. Therefore, in the present invention, it is preferred that the heat treatment time be 2 to 70 minutes.

In the present invention, the heat treatment method used in the heat treatment step is not restricted and an arbitrary method, such as a method using a heating resistor, a dielectric heating method (e.g., microwave heating) or a photoheating method, can be selected. When performing the heat treatment, in order to prevent a change in the concentration of the evaluation solution caused by concentration due to evaporation of water, it is preferred that heat be applied in a hermetically sealed condition.

Further, as described in the above, in the hydrogen peroxide detection step according to the present invention, a hydrogen peroxide detection method using any one selected from absorbance, electrochemical process, ultrasonic wave, density and refractive index can be suitably employed.

Thereamong, in the hydrogen peroxide detection step according to the present invention, it is preferred that hydrogen peroxide be detected by measuring the absorbance at a wavelength of 220 to 290 nm, particularly 240 to 280 nm. The absorption peak wavelength of hydrogen peroxide is about 190 nm. Therefore, conventionally, this wavelength is generally employed; however, the present inventors discovered that, by using the absorbance measured at a wavelength in the above-described range, not only the measurement accuracy can be improved and the flow-rate dependency of evaluation solution can be reduced, but also the detection can be effectively performed also from the cost standpoint since less expensive members can be used. In cases where the measurement wavelength is shorter than 220 nm, when the evaluation solution contains sulfuric acid, the light absorption of sulfuric acid overlaps with that of the oxidizing agents, so that the measurement results vary depending on the sulfuric acid concentration. Meanwhile, when the measurement wavelength is longer than 290 nm, since the light absorption by hydrogen peroxide is small, the measurement accuracy is reduced.

Further, when the same wavelength as that of the absorption peak of hydrogen peroxide is used for the measurement, since hydrogen peroxide in the evaluation solution is decomposed by light, the concentration of hydrogen peroxide in the evaluation solution decreases with time. Accordingly, in this case, the evaluation solution must be fed at a certain flow rate or higher in the hydrogen peroxide detection step where absorbance is utilized. In contrast to this, by using a wavelength different from the absorption peak wavelength of hydrogen peroxide, the decomposition of the substance to be evaluated in an absorption-measuring cell is inhibited, so that a change in the concentration of the evaluation solution during the measurement is not likely to occur and the flow-rate dependency of the evaluation solution in the measurement results is reduced. Further, when a light having a wavelength of shorter than 220 nm is used, since a quartz through which such a short-wavelength light can pass must be used as the measurement cell, the process becomes expensive. Therefore, in the present invention, the luminous wavelength to be used in the hydrogen peroxide detection method utilizing absorbance is preferably 220 to 290 nm.

It is noted here that the length of the measurement cell used in the hydrogen peroxide detection step utilizing absorbance is not particularly restricted and can be set arbitrarily in accordance with the concentration of the oxidizing agent to be evaluated.

In the present invention, when an electrochemical process is employed as the hydrogen peroxide detection method in the hydrogen peroxide detection step, the electrochemical process can be a controlled-potential electrolysis method or a potential-scanning method; however, the use of a controlled-potential electrolysis method is more preferred since it does not require a function generator and this leads to a simpler device structure.

The above-described controlled-potential electrolysis method is a method in which the value of the electric current flowing through a working electrode is measured by retaining the working electrode at a prescribed electric potential or voltage. When the flow rate of the evaluation solution is maintained constant, the current is proportional to the concentration of the reaction product, that is, the concentration of hydrogen peroxide; therefore, such a method can be applied in a concentration meter. By performing the measurement continuously, the concentration of the reaction product can be monitored continuously.

In the present invention, it is preferred that the electric potential or voltage applied in the controlled-potential electrolysis method be an electric potential or voltage at which hydrogen peroxide is oxidized or reduced but different from the water electrolysis potential (electric potential at which oxygen or hydrogen is generated). That is, in cases where the detection utilizes the oxidation reaction of hydrogen peroxide, it is preferred to retain the working electrode at an electric potential at which oxygen is not generated but hydrogen peroxide is oxidized. Further, in cases where the detection utilizes the reduction reaction of hydrogen peroxide, it is preferred to retain the working electrode at an electric potential at which hydrogen is not generated but hydrogen peroxide is reduced. The reason for this is that, when oxygen or hydrogen is generated simultaneously with the oxidation or reduction reaction of hydrogen peroxide, it cannot be judged whether the detected current is attributed to electrochemical reaction of hydrogen peroxide, electrolysis reaction of water or a combination thereof, so that the measurement accuracy is reduced.

In cases where the working electrode is retained at a prescribed electric potential in the above-described controlled-potential electrolysis method, as an electrolytic cell, a three-electrode cell having a working electrode, a counter electrode and a reference electrode can be employed. Further, in cases where the working electrode is retained at a prescribed voltage, as an electrolytic cell, a two-electrode cell having a working electrode and a counter electrode can be employed. In these cases, the counter electrode may be of an arbitrary material and, for example, platinum or a carbon material is suitable as the material. The reference electrode may also be of an arbitrary material and, for example, a silver-silver chloride electrode is suitably as the material.

The working electrode used in the above-described controlled-potential electrolysis method is not particularly restricted; however, the material thereof is preferably platinum or a carbon material such as conductive diamond or graphite. Particularly, a platinum electrode and a conductive diamond electrode are more preferred. Since a platinum electrode and a conductive diamond electrode have high durability, the service life of the concentration meter is extended, and their small electric double layer capacity improves the measurement accuracy. Further, since a carbon material has a low catalytic activity and is thus not likely to facilitate self-decomposition of the oxidizing agents, a change in the total concentration of oxidizing agents is not likely to occur except by progress of an electrochemical oxidation or reduction reaction, so that a high measurement accuracy can be attained.

The above-described potential-scanning method is a method in which the electric potential of working electrode is scanned to read the peak current of oxidation or reduction of hydrogen peroxide. In this case, as an electrolytic cell, a three-electrode cell having a working electrode, a counter electrode and a reference electrode can be employed. Scanning of electric potential requires a potentiostat integrated with a function generator.

The concentration meter for measuring the total concentration of oxidizing agents according to the present invention is used to measure the total concentration of oxidizing agent(s) in an evaluation solution containing at least one oxidizing agent and comprises a storage section where the evaluation solution is stored, a heat treatment section where the evaluation solution in the storage section is heated to a prescribed temperature and a hydrogen peroxide detecting section where hydrogen peroxide in the thus heat-treated evaluation solution is detected.

In the concentration meter of the present invention, it is preferred that the storage section where the evaluation solution is stored comprise, in addition to an interior space for storing the evaluation solution, a flow path through which the evaluation solution is supplied and discharged and, externally or in the interior space, a heating means for heating the evaluation solution. This heating means constitutes a part of the below-described heat treatment section. The shape of the storage section is not particularly restricted. Further, the constituent material thereof is also not particularly restricted; however, it is preferably, for example, a fluorocarbon resin such as polytetrafluoroethylenc (PTFE) or tetrafluoroethylene-perfluoroalkyl vinyl ether copolymer (PFA), a glass or a quartz, which has sulfuric acid resistance, heat resistance, oxidation resistance and the like.

In the present invention, the storage section may be integrated with a measurement cell to form a storage-measurement cell or may be provided as a separate member; however, in cases where the storage section and the measurement cell are integrated and absorbance is utilized in the hydrogen peroxide detection step, it is preferred that the storage section be made of a glass or quartz through which a light having a measurement wavelength can pass.

Further, in the concentration meter of the present invention, the heat treatment section comprises a heating means for heating the evaluation solution stored in the storage section and a temperature control means for controlling the temperature of the evaluation solution and may further comprise a cooling means for cooling the evaluation solution stored in the storage section. Here, as described in the above, an arbitrary heat treatment method can be applied as the heating means. As the temperature control means, a known method can be appropriately used and it is not particularly restricted. For example, as the temperature control means, a system in which a temperature-measuring sensor such as a thermocouple or a thermistor is connected to the heat treatment section and the heating power is controlled to be “OFF” when the temperature of the evaluation solution reached a prescribed temperature or higher and “ON” when the temperature is lower than the prescribed temperature can be employed. In this case, it is preferred that the correlation between the temperature of the heat treatment section and the actual temperature of the evaluation solution be experimentally investigated in advance and that, when the evaluation solution is heat-treated, the temperature thereof be controlled with reference to the correlation.

Further, in the concentration meter of the present invention, it is preferred that the hydrogen peroxide detecting section comprise, as a detection means, any one selected from an absorbance meter, an electrochemical measuring instrument, an ultrasonic meter, a densimeter and a refractometer. These detection instruments are not particularly restricted and a general-purpose device can be appropriately used.

The concentration meter of the present invention can be utilized as a concentration meter attached to a device by connecting it to a factory piping, a device piping or the like, through which the evaluation solution is circulated, in the upstream and to a waste discharge piping in the downstream. The method of connecting the concentration meter to such pipings can be selected arbitrarily and, for example, a pipe branching from a factory piping, a device piping or the like can be connected to the concentration meter, which may, in turn, be connected to a waste discharge piping.

The sulfuric acid electrolysis device of the present invention comprises the above-described concentration meter for measuring the total concentration of oxidizing agents according to the present invention. In the present invention, in cases where the concentration meter is used in connection with the sulfuric acid electrolysis device, the evaluation solution can be made to continuously pass through the concentration meter to continuously monitor the concentration thereof. Alternatively, at prescribed time intervals or for the purpose of verifying the final concentration or the like, the concentration of the evaluation solution can be measured discontinuously as required.

In the sulfuric acid electrolysis device of the present invention, as a sulfuric acid electrolytic bath, there is no particular restriction and an electrolytic bath in which conductive diamond is used as both anode and cathode and a membrane made of a porous PTFE is used as a separator membrane can be suitably employed. In the electrolysis step performed by such a sulfuric acid electrolysis device, as a first process, a concentrated sulfuric acid and ultrapure water are fed to an anolyte tank through a concentrated sulfuric acid supply line and an ultrapure water supply line, respectively, and the sulfuric acid concentration is adjusted in the anolyte tank. Here, the sulfuric acid concentration does not have to be adjusted in the anolyte tank and a sulfuric acid whose concentration has been adjusted in advance may be fed to the anolyte tank instead. In this case, the sulfuric acid solution can be adjusted to have an arbitrary concentration. Then, as a second process, the sulfuric acid solution in the anolyte tank is pressure-fed to an anode chamber by an anolyte circulation pump and electrolyzed. By this process, an electrolyzed sulfuric acid containing oxidizing agents is produced at the anode. Further, as a third process, using the anolyte circulation pump, an electrolyte is circulated along with a generated anode gas through anolyte supply line, anode chamber, anolyte circulation line and anolyte tank to perform electrolysis thereof continuously with sufficient stirring. Here, alternatively, so-called one-pass method in which an electrolyte is passed through an electrolytic cell only once without being circulated may also be employed. In this case, an anode gas is separated from liquid in the anolyte tank and discharged out of the device. In the side of a catholyte tank as well, although not described herein, an electrolyte can be circulated and stirred in the same manner by the same mechanism.

In the present invention, in cases where the concentration meter is used in connection with the sulfuric acid electrolysis device, the connection position of the concentration meter is not particularly restricted and the concentration meter can be arranged at an arbitrary position; however, it is preferred that the concentration meter be connected to the anolyte tank or the anolyte circulation line provided immediately downstream of the electrolytic cell. In this case, the evaluation solution may be directly fed from the anode tank, circulation line or the like of the above-described sulfuric acid electrolysis device to the concentration meter for measuring the total concentration of oxidizing agents. Alternatively, the evaluation solution may be once fed to an evaluation solution tank from the above-described circulation line or anode tank and then fed to the concentration meter.

Further, in the present invention, in cases where the concentration meter is used in connection with the sulfuric acid electrolysis device, with a prescribed total concentration of the oxidizing agents being set as a target value based on the result of measurement by the concentration meter, the sulfuric acid electrolysis device can be operated while controlling its electrolysis time, current, temperature, liquid retention time and the like.

### EXAMPLES

The present invention will now be described concretely by way of examples and comparative examples thereof; however, the present invention is not restricted thereto.

In the present invention, preparation of evaluation solutions, concentration measurement of peroxodisulfate ion, peroxomonosulfate ion and hydrogen peroxide in the thus prepared evaluation solutions by Raman spectroscopy, and concentration measurement of oxidizing agents in the respective evaluation solutions after heat treatment by absorption spectroscopy and controlled-potential method were carried out in accordance with the below-described methods. The conditions of electrolysis, heat treatment and hydrogen peroxide detection in Examples and Comparative Examples are summarized in Tables 1, 3, 5 and 7 below.

### <Preparation of Evaluation Solution (Sulfuric Acid Solution)>

The weight of 98% sulfuric acid (H₂SO₄: manufactured by Kanto Chemical Co., Inc.) required to prepare 1 litre of an evaluation solution was calculated based on the following Formula (4) and taken in a 1-litre volumetric flask. Then, ultrapure water was added thereto to prepare an evaluation solution having a total volume of 1 litre.

$$A ( g ) = \frac{\begin{matrix}Concentration of {H}_{2} {SO}_{4} to be prepared ( mol \text{/} l ) \times \\ Molar mass of {H}_{2} {SO}_{4} ( 98 g \text{/} mol ) 100\end{matrix}}{98} \qquad ( 4 )$$

(wherein, A (g) represents the weight of 98% sulfuric acid required to prepare 1 litre of an evaluation solution)

### <Preparation of Evaluation Solution (Electrolyzed Sulfuric Acid Solution)>

Using a separator membrane-equipped electrolytic cell comprising conductive diamond electrodes of 1,000 dm² in electrolytic area as both anode and cathode, sulfuric acid was electrolyzed with circulation of an anolyte and a catholyte to produce an electrolyzed sulfuric acid solution in accordance with the following conditions. An evaluation solution was prepared in an amount of 1 litre based on the above-described Formula (4), and 300 ml of the thus prepared evaluation solution was used as the anolyte and other 300 ml was used as the catholyte. The electrolysis time was adjusted in accordance with the total concentration of oxidizing agents.
Cell current: 100 A
Current density: 100 A/dm²
Amount of anolyte: 300 ml
Solution temperature: 28° C.
Anolyte flow rate: 1 l/min
Catholyte flow rate: 1 l/min
Anolyte: sulfuric acid solution
Catholyte: sulfuric acid solution
Separator membrane: (POREFLON (registered trademark) manufactured by Sumitomo Electric Fine Polymer, Inc.)

### <Preparation of Evaluation Solution (Ammonium Peroxodisulfate-Sulfuric Acid Solution)>

The weights of 98% sulfuric acid (manufactured by Kanto Chemical Co., Inc.) and ammonium peroxodisulfate ((NH₄)₂S₂O₄: manufactured by Wako Pure Chemical Industries, Ltd.) required to prepare 1 litre of an evaluation solution were calculated based on the above-described Formula (4) and the following Formula (5), respectively, and placed in a 1-litre volumetric flask. Then, ultrapure water was added thereto to prepare an evaluation solution having a total volume of 1 litre. It is noted here that the preparation of the evaluation solution was carried out while cooling the bottom of the volumetric flask with cooling water such that an increase in the temperature of the evaluation solution was inhibited.

$$B ( g ) = Concentration of ( {( N H )}_{4} ) {}_{2}^{}{S}{}_{2}^{} {O}_{8} to be prepared ( mol \text{/} l ) \times Molar mass of ( {( N H )}_{4} ) {}_{2}^{}{S}{}_{2}^{} {O}_{8} ( 228.2 g \text{/} mol ) \qquad ( 5 )$$

(wherein, B (g) represents the weight of ammonium peroxodisulfate required to prepare 1 litre of an evaluation solution)

### <Preparation of Evaluation Solution (Peroxomonosulfate-Sulfuric Acid Solution)

The weights of 98% sulfuric acid (manufactured by Kanto Chemical Co., Inc.) and OXONE (registered trademark) monopersulfate compound (2 KHSO₅.KHSO₄.K₂SO₄: manufactured by Wako Pure Chemical Industries, Ltd.) required to prepare 1 litre of an evaluation solution were calculated based on the above-described Formula (4) and the following Formula (6), respectively, and placed in a 1-litre volumetric flask. Then, ultrapure water was added thereto to prepare an evaluation solution having a total volume of 1 litre. The preparation of the electrolyte was carried out while cooling the bottom of the volumetric flask with cooling water such that an increase in the temperature of the electrolyte was inhibited.

$$C ( g ) = \frac{ \begin{matrix}Concentration of 2 {KHSO}_{5} \cdot {KHSO}_{4} \cdot {K}_{2} {SO}_{4} \\ to be prepared ( mol / l ) \times Molar mass of \\ 2 {KHSO}_{5} \cdot {KHSO}_{4} \cdot {K}_{2} {SO}_{4} ( 614.8 g / mol )\end{matrix}}{2} \qquad ( 6 )$$

(wherein, C (g) represents the weight of OXONE (registered trademark) monopersulfate required to prepare 1 litre of an electrolyte)

### <Preparation of Evaluation Solution (Hydrogen Peroxide-Sulfuric Acid Solution)>

The weights of 98% sulfuric acid (manufactured by Kanto Chemical Co., Inc.) and 35% hydrogen peroxide (H₂O₂: manufactured by manufactured by Wako Pure Chemical Industries, Ltd.) required to prepare 1 litre of an evaluation solution were calculated based on the above-described Formula (4) and the following Formula (7), respectively, and placed in a 1-litre volumetric flask. Then, ultrapure water was added thereto to prepare an electrolyte having a total volume of 1 litre. The preparation of the electrolyte was carried out while cooling the bottom of the volumetric flask with cooling water such that an increase in the temperature of the electrolyte was inhibited.

$$D ( g ) = \frac{\begin{matrix}Concentration of {H}_{2} {O}_{2} to be prepared ( mol \text{/} l ) \times \\ Molar mass of {H}_{2} {O}_{2} ( 34.0 g \text{/} mo l ) \times 100 \end{matrix}}{35} \qquad ( 7 )$$

(wherein, D (g) represents the weight of hydrogen peroxide required to prepare 1 litre of an electrolyte)

### <Evaluation of Acid Concentration in Evaluation Solution>

To a 100-ml volumetric flask, 0.4 ml of an evaluation solution was added, and the volume thereof was adjusted to 100 ml with ultrapure water. Then, 5 ml of the resulting solution and one drop of phenolphthalein were added to a beaker and titrated with 0.1M NaOH (manufactured by Wako Pure Chemical Industries, Ltd.) until a color developed. The acid concentration was calculated based on the following Formula (8).

$$Acid concentration ( mol / L ) = \frac{\begin{matrix}Titration amount ( mL ) \times \\ Concentration of NaOH ( 0.1 mol / L ) Dilution factor ( 250 )\end{matrix}}{\begin{matrix}Amount of recovered solution after \\ adjustment ( 5 ml ) \times Stoichiometric coefficient of NaOH ( 1 )\end{matrix}} \qquad ( 8 )$$

### <Measurement of Concentrations of Peroxodisulfate Ion, Peroxomonosulfate Ion and Hydrogen Peroxide in Evaluation Solution by Raman Spectroscopy>

The concentrations of peroxodisulfate ion, peroxomonosulfate ion and hydrogen peroxide in the thus prepared evaluation solution were measured by Raman spectroscopy. The measurement conditions and method were as shown below. An ammonium peroxodisulfate solution, a peroxomonosulfuric acid solution and a hydrogen peroxide solution, all of which had a known concentration, were prepared and measured based on the above-described Formulae (5), (6) and (7), respectively. From the total concentration of the loaded oxidizing agents and the results of the Raman spectroscopy, a calibration curve was prepared to be used in concentration conversion.
Measuring apparatus: Raman spectrophotometer, manufactured by Thermo Fisher Scientific K.K.
Model: AlMEGA XR
Laser light: 532 nm
Exposure time: 2.00 seconds
Number of exposure: 20
Number of background exposure: 20
Grating: 672 lines/mm
Measuring width: 700 to 1500 cm⁻¹
Spectrometer aperture: 25-μm slit
Low-resolution measurement in a macro laboratory
Spectral correction: From the intensity of the entire range, a baseline value obtained by drawing a straight line connecting the intensities at 710 cm⁻¹ and 1,140 cm⁻¹ was subtracted.
For the measurement of the peroxodisulfuric acid concentration, the intensity at 832 cm⁻¹ was used.
For the measurement of the peroxomonosulfuric acid concentration, the intensity at 770 cm⁻¹ was used.
For the measurement of the hydrogen peroxide concentration, the intensity at 872 cm⁻¹ was used.
   <Measurement of Total Concentration of Oxidizing Agents in Evaluation Solution after Heat Treatment by Absorption Spectroscopy>

Measurement of the total concentration of oxidizing agents in an evaluation solution after the heat treatment by absorption spectroscopy was performed in accordance with the below-described conditions and method. Based on the method of preparing an evaluation solution (ammonium peroxodisulfate-sulfuric acid solution), ammonium peroxodisulfate-sulfuric acid solutions having different total concentrations of oxidizing agents and an acid concentration of 14.24% by mass were prepared. After heat-treating the thus obtained solutions at 105° C. for 20 minutes, the resulting solutions were measured at each measurement wavelength and, from the total concentration of the loaded oxidizing agents and the results of absorbance measurement, a calibration curve was prepared to be used in concentration conversion.
Measuring apparatus: ultraviolet and visible spectrophotometer, manufactured by JASCO Corporation
Model: V-650
Measurement wavelength: 190.0 nm, 253.7 nm and 300.0 nm
Photometric mode: Abs
Response: medium
Number of replication: 3 times
Cell length: 0.05 mm (wavelength=190.0 nm), 0.2 mm (wavelength=253.7 nm and 300.0 nm)
   <Measurement of Total Concentration of Oxidizing Agents in Evaluation Solution after Heat Treatment by Controlled-Potential Method>

Measurement of the total concentration of oxidizing agents in an evaluation solution after the heat treatment by a controlled-potential method was performed under the below-described conditions by taking 50 ml of the evaluation solution in a 100-ml glass beaker cell. The evaluation solution was stirred at 500 rpm using a PASOLINA mini stirrer (CT-1A, manufactured by AS ONE Corporation). Here, ammonium peroxodisulfate-sulfuric acid solutions having different total concentrations of oxidizing agents and an acid concentration of 14.24% by mass were prepared in accordance with the method of preparing an evaluation solution (ammonium peroxodisulfate-sulfuric acid solution). After heat-treating the thus obtained solutions at 105° C. for 20 minutes, the current thereof was measured at each electric potential and, from the total concentration of the loaded oxidizing agents and the measured current values, a calibration curve was prepared to be used in concentration conversion.
Working electrode: made of the respective working electrode material
Working electrode area: 0.03 mm²
Counter electrode: platinum mesh
Reference electrode: Ag/AgCl (internal solution: saturated KCl)
Measuring apparatus: HABF-5001, manufactured by Hokuto Denko Corp.
Sampling cycle: 50 ms

### <Evaluation of Reproducibility>

In the above-described absorption spectroscopy and controlled-potential method, the total concentration of oxidizing agents in the evaluation solution after the heat treatment was measured three times to verify the reproducibility. The results thereof were evaluated by the criteria based on the following equation.

(Difference between Minimum value of the absorbance or current and Maximum value of the absorbance or current)/(Average value of the absorbance or current)×100(%)
3% or less:
Higher than 3% but not higher than 5%: ◯
Higher than 5% but not higher than 10: Δ
Higher than 10%: x

### Example 1

In a 1-litre volumetric flask, 712 g of 98% sulfuric acid (manufactured by Kanto Chemical Co., Inc.) was taken based on the above-described Formula (4) and then diluted to a total volume of 1 litre with addition of ultrapure water, thereby preparing an electrolyte containing sulfuric acid at a concentration of 7.12 mol/l. Using 300 ml of the thus prepared electrolyte as an anolyte and other 300 ml as a catholyte, an evaluation solution was prepared in accordance with the method of preparing an evaluation solution (electrolyzed sulfuric acid solution).

When the thus prepared evaluation solution was evaluated in accordance with the method of measuring the concentrations of peroxodisulfate ion, peroxomonosulfate ion and hydrogen peroxide in an evaluation solution by Raman spectroscopy, the evaluation solution was found to have a peroxodisulfuric acid concentration of 0.23 mol/l, a peroxomonosulfuric acid concentration of 0.67 mol/l and a hydrogen peroxide concentration of 0.10 mol/l. Further, when the evaluation solution was measured in accordance with the acid concentration evaluation method, the evaluation solution was found to have an acid concentration of 14.24 mol/l.

Then, 10 minutes after being prepared, this evaluation solution in an amount of 10 ml was taken in a 20-ml vial, which was used as a storage section whose periphery was covered with a rubber heat as a heat treatment means, and heat-treated at 105° C. for 20 minutes. Thereafter, the resulting evaluation solution was evaluated in accordance with the method of measuring the hydrogen peroxide concentration and total concentration of oxidizing agents in an evaluation solution by Raman spectroscopy and the method of evaluating the total concentration of oxidizing agents by absorption spectroscopy using a 0.2 mm-long measurement cell. The results thereof are shown in Table 2 below.

Here, from the standpoint of the measurement accuracy, a change in the oxidizing agent concentration of 10% or less before and after the heat treatment can be considered satisfactory. Further, from the standpoint of the measurement accuracy, a ratio of hydrogen peroxide after the heat treatment of 60% or higher can be considered satisfactory, and it is more preferably 70% or higher, still more preferably 80% or higher. Moreover, from the standpoint of the measurement accuracy, the change in the total concentration, which is represented by an equation: (Total concentration−Concentration before the heat treatment)/Total concentration before the heat treatment, is considered satisfactory at 10% or less, and it is more preferably 5% or less. Furthermore, with regard to the reproducibility, from the standpoint of the measurement accuracy, an evaluation of “x” is judged to be poor.

### Examples 2 and 3

As Examples 2 and 3, the total concentration of oxidizing agents in evaluation solutions was measured in the same manner as in Example 1, except that a solution having a different total concentration of the oxidizing agents and ratio of the oxidizable components, which was prepared by changing the total concentration of the oxidizing agents in the electrolyzed sulfuric acid solution and the time between the preparation of the evaluation solution and the start of the measurement, was used as each evaluation solution. The results thereof are shown in Table 2 below.

### Example 4

The total concentration of oxidizing agents in an evaluation solution was measured in the same manner as in Example 1, except that a solution having a sulfuric acid concentration of 7.12 mol/l and a peroxodisulfuric acid concentration of 0.3 mol/l, which was prepared by taking, in a 1-litre volumetric flask, 712 g of 98% sulfuric acid (manufactured by Kanto Chemical Co., Inc.) based on the above-described Formula (4) and ammonium peroxodisulfate ((NH₄)₂S₂O₄: manufactured by Wako Pure Chemical Industries, Ltd.) based on the above-described Formula (5) and then diluting the resulting solution to a total volume of 1 litre with addition of ultrapure water, was used as the evaluation solution. The results thereof are shown in Table 2 below.

### Example 5

The total concentration of oxidizing agents in an evaluation solution was measured in the same manner as in Example 1, except that an electrolyte containing sulfuric acid at a concentration of 3.00 mol/l was prepared based on the above-described Formula (4) and that the acid concentration of the evaluation solution and the heat treatment temperature were changed as shown in the table. The results thereof are shown in Table 2 below.

### Example 6 to 8

The total concentration of oxidizing agents in an evaluation solution was measured in the same manner as in Example 1, except that an electrolyte containing sulfuric acid at a concentration of 3.50, 8.11 or 9.17 mol/l was prepared based on the above-described Formula (4) and that the acid concentration of the respective evaluation solutions was changed as shown in the table. The results thereof are shown in Table 2 below.

TABLE 1

| | | Example 1 | Example 2 | Example 3 | Example 4 | Example 5 | Example 6 | Example 7 | Example 8 |
|---|---|---|---|---|---|---|---|---|---|
| Electrolyte | Acid concentration (mol/l) | 14.24 | 14.24 | 14.24 | 14.24 | 6.00 | 7.00 | 16.22 | 18.34 |
| | Peroxodisulfuric acid | 0.23 | 0.47 | 0.20 | 0.30 | 0.65 | 0.55 | 0.20 | 0.35 |
| | concentration (mol/l) | | | | | | | | |
| | Peroxomonosulfuric acid | 0.67 | 0.03 | 0.42 | — | 0.35 | 0.45 | 0.70 | 0.55 |
| | concentration (mol/l) | | | | | | | | |
| | Hydrogen peroxide | 0.10 | — | 0.38 | — | 0.00 | 0.00 | 0.10 | 0.10 |
| | concentration (mol/l) | | | | | | | | |
| | Total concentration of | 1.00 | 0.50 | 1.00 | 0.30 | 1.00 | 1.00 | 1.00 | 1.00 |
| | oxidizing agents (mol/l) | | | | | | | | |
| Heat treatment | Time between preparation | 10 | 10 | 540 | 10 | 10 | 10 | 10 | 10 |
| step | of electrolyte and heat | | | | | | | | |
| | treatment (min) | | | | | | | | |
| | Heat treatment | 105 | 105 | 105 | 105 | 105 | 105 | 105 | 105 |
| | temperature (° C.) | | | | | | | | |
| | Heat treatment time (min) | 20 | 20 | 20 | 20 | 20 | 20 | 20 | 20 |

| | | |
|---|---|---|
| Hydrogen peroxide | Measurement wavelength | 253.7 |
| detection step | (nm) | |
| (by absorption | | |
| spectroscopy) | | |

TABLE 2

| | | Example 1 | Example 2 | Example 3 | Example 4 | Example 5 | Example 6 | Example 7 | Example 8 |
|---|---|---|---|---|---|---|---|---|---|
| Results | Total concentration of | 1.01 | 0.50 | 1.00 | 0.30 | 1.00 | 1.00 | 0.97 | 0.96 |
| obtained by | oxidizing agents after | | | | | | | | |
| Raman | heat treatment (mol/l) | | | | | | | | |
| spectroscopy | Ratio of hydrogen | 90 | 88 | 92 | 87 | 36 | 65 | 93 | 90 |
| | peroxide after heat | | | | | | | | |
| | treatment (%) | | | | | | | | |
| | Change in the total | 1 | 0 | 0 | 0 | 0 | 0 | −3 | −4 |
| | concentration of | | | | | | | | |
| | oxidizing agents before | | | | | | | | |
| | and after heat | | | | | | | | |
| | treatment (%) | | | | | | | | |
| Results | Absorbance | 0.350 | 0.173 | 0.364 | 0.104 | 0.300 | 0.329 | 0.353 | 0.350 |
| obtained by | Total concentration of | 1.01 | 0.50 | 1.05 | 0.30 | 0.87 | 0.95 | 1.02 | 1.01 |
| absorption | oxidizing agents after | | | | | | | | |
| spectroscopy | heat treatment (mol/l) | | | | | | | | |
| | Reproducibility | | | | | | | | |

| | | | | | | | | |
|---|---|---|---|---|---|---|---|---|
| (Total concentration determined by | 1 | 0 | 5 | 0 | −13 | −5 | 2 | 1 |
| absorption spectroscopy − Total | | | | | | | | |
| concentration before heat | | | | | | | | |
| treatment)/Total concentration before | | | | | | | | |
| heat treatment × 100 (%) | | | | | | | | |

In Example 1, the ratio of hydrogen peroxide in the total concentration of the oxidizing agents in the evaluation solution after the heat treatment was very high at 90%. Further, the change in the total concentration of the oxidizing agents in the evaluation solution before and after the heat treatment was low at 1%; therefore, it was confirmed that the total concentration of the oxidizing agents was not reduced by self-decomposition caused by the heat treatment. Moreover, the absorbance determined by absorption spectroscopy was 0.350 and the concentration calculated therefrom was 1.01 mol/l. It was also found that the measurement accuracy was high, with the difference in the total concentration of the oxidizing agents between the result obtained by absorption spectroscopy and the result obtained by Raman spectroscopy performed before the heat treatment being small. As for the evaluation of the reproducibility, the reproducibility was found to be high for both the second and the third measurements at 0.351 and 0.350, respectively.

In addition, from Examples 1 to 4, it was found that, even when evaluation solutions containing different oxidizing agents and having different concentrations of the respective components were evaluated, by using the method of measuring the total concentration of oxidizing agents according to the present invention, the total concentration of the oxidizing agents can be accurately measured with good reproducibility.

According to Example 5, the change in the total concentration of the oxidizing agents before and after the heat treatment was satisfactory and the reproducibility was good when the evaluation solution had an acid concentration of 6.00 mol/l; however, the ratio of hydrogen peroxide after the heat treatment was 36% and the measurement accuracy was rather low with the difference in the total concentration of the oxidizing agents between the result obtained by absorption spectroscopy and the result obtained by Raman spectroscopy performed before the heat treatment being −13%. This is believed to be because the heat treatment was not sufficient and the reactions of the above-described Formulae (1) and (2), therefore, did not proceed sufficiently.

According to Examples 7 and 8, it was found that, when the evaluation solution had a high acid concentration of 16.22 or 18.34 mol/l, although the reproducibility was good and the measurement accuracy was high with the difference in the total concentration of the oxidizing agents between the result obtained by absorption spectroscopy and the result obtained by Raman spectroscopy performed before the heat treatment being small, the change in the oxidizing agent concentration before and after the heat treatment was larger as compared to Example 1. This is believed to be because, as the acid concentration becomes higher, hydrogen peroxide generated by the reaction of the above-described Formula (2) is more quickly eliminated by the self-decomposition reaction of the above-described Formula (3).

From the above-described results, it was found that there is an optimum acid concentration of an evaluation solution for improving the measurement accuracy.

### Examples 9 and 10

The total concentration of oxidizing agents in an evaluation solution was measured in the same manner as in Example 1, except that an electrolyte containing sulfuric acid at a concentration of 9.17 mol/l was prepared based on the above-described Formula (4) and that the acid concentration and heat treatment temperature of the respective evaluation solutions were changed as shown in the table. The results thereof are shown in Table 4 below.

### Examples 11 and 12

The total concentration of oxidizing agents in an evaluation solution was measured in the same manner as in Example 1, except that the heat treatment temperature of the respective evaluation solutions was changed as shown in the table. The results thereof are shown in Table 4 below.

### Examples 13 to 15

The total concentration of oxidizing agents in an evaluation solution was measured in the same manner as in Example 1, except that an electrolyte containing sulfuric acid at a concentration of 9.17 mol/l was prepared based on the above-described Formula (4) and that the acid concentration and heat treatment temperature of the respective evaluation solutions were changed as shown in the table. The results thereof are shown in Table 4 below.

TABLE 3

| | | Example 9 | Example 10 | Example 11 | Example 12 | Example 13 | Example 14 | Example 15 |
|---|---|---|---|---|---|---|---|---|
| Electrolyte | Acid concentration (mol/l) | 18.34 | 18.34 | 14.24 | 14.24 | 18.34 | 18.34 | 18.34 |
| | Peroxodisulfuric acid | 0.35 | 0.35 | 0.23 | 0.23 | 0.35 | 0.35 | 0.35 |
| | concentration (mol/l) | | | | | | | |
| | Peroxomonosulfuric acid | 0.55 | 0.55 | 0.67 | 0.67 | 0.55 | 0.55 | 0.55 |
| | concentration (mol/l) | | | | | | | |
| | Hydrogen peroxide | 0.10 | 0.10 | 0.10 | 0.10 | 0.10 | 0.10 | 0.10 |
| | concentration (mol/l) | | | | | | | |
| | Total concentration of | 1.00 | 1.00 | 1.00 | 1.00 | 1.00 | 1.00 | 1.00 |
| | oxidizing agents (mol/l) | | | | | | | |
| Heat treatment | Time between preparation | 10 | 10 | 10 | 10 | 10 | 10 | 10 |
| step | of electrolyte and heat | | | | | | | |
| | treatment (min) | | | | | | | |
| | Heat treatment | 81 | 124 | 81 | 124 | 105 | 105 | 105 |
| | temperature (° C.) | | | | | | | |
| | Heat treatment time (min) | 20 | 20 | 20 | 20 | 1 | 49 | 75 |

| | | |
|---|---|---|
| Hydrogen peroxide | Measurement wavelength | 253.7 |
| detection step | (nm) | |
| (absorption | | |
| spectroscopy) | | |

TABLE 4

| | | Example 9 | Example 10 | Example 11 | Example 12 | Example 13 | Example 14 | Example 15 |
|---|---|---|---|---|---|---|---|---|
| Results | Total concentration of | 0.97 | 0.94 | 1.00 | 0.99 | 1.00 | 0.95 | 0.93 |
| obtained by | oxidizingagents after | | | | | | | |
| Raman | heat treatment (mol/l) | | | | | | | |
| spectroscopy | Ratio of hydrogen | 96 | 91 | 40 | 94 | 60 | 88 | 97 |
| | peroxide after heat | | | | | | | |
| | treatment (%) | | | | | | | |
| | Change in the total | −3 | −6 | 0 | −1 | 0 | −5 | −7 |
| | concentration of | | | | | | | |
| | oxidizing agents before | | | | | | | |
| | and after heat | | | | | | | |
| | treatment (%) | | | | | | | |
| Results | Absorbance | 0.343 | 0.382 | 0.319 | 0.367 | 0.308 | 0.350 | 0.323 |
| obtained by | Total concentration of | 0.99 | 1.10 | 0.92 | 1.06 | 0.89 | 1.01 | 0.93 |
| absorption | oxidizing agents after | | | | | | | |
| spectroscopy | heat treatment (mol/l) | | | | | | | |
| | Reproducibility | | | | | | | |

| | | | | | | | |
|---|---|---|---|---|---|---|---|
| (Total concentration determined by | −1 | 10 | −8 | 6 | −11 | 1 | −7 |
| absorption spectroscopy − Total | | | | | | | |
| concentration before heat | | | | | | | |
| treatment)/Total concentration before | | | | | | | |
| heat treatment × 100 (%) | | | | | | | |

According to Examples 9 and 10, in the case of the evaluation solutions having an acid concentration of 18.34 mol/l, as the heat treatment temperature was increased, the change in the oxidizing agent concentration before and after the heat treatment became larger. In addition, because of this, at a heat treatment temperature of 124° C., the difference in the total concentration of the oxidizing agents between the result obtained by absorption spectroscopy and the result obtained by Raman spectroscopy performed before the heat treatment was large.

According to Examples 11 and 12, in the case of the evaluation solutions having an acid concentration of 14.24 mol/l, it was found that the ratio of hydrogen peroxide after the heat treatment was low at 40% when the heat treatment temperature was 81° C. This is believed to be because the heat treatment was not sufficient and the reactions of the Formulae (1) and (2), therefore, did not proceed sufficiently. Consequently, the difference in the total concentration of the oxidizing agents between the result obtained by absorption spectroscopy and the result obtained by Raman spectroscopy performed before the heat treatment was large.

Further, the reproducibility of the evaluation was found to be high in all of Examples 9 to 12.

By the above-described results, it was shown that the heat treatment temperature is closely related to the acid concentration and that there is an optimum value thereof.

From Example 13, it was found that the ratio of hydrogen peroxide after the heat treatment was low at 60% when the heat treatment time was 1 minute. This is believed to be because the heat treatment was not sufficient and the reactions of the above-described Formulae (1) and (2), therefore, did not proceed sufficiently. Consequently, the difference in the total concentration of the oxidizing agents between the result obtained by absorption spectroscopy and the result obtained by Raman spectroscopy performed before the heat treatment was large.

From Examples 14 and 15, it was found that, when the heat treatment time was extended, although the reproducibility remained high, the change in the oxidizing agent before and after the heat treatment became large. This is believed to be because the reaction of the above-described Formula (3) proceeded due to the heat treatment. Consequently, when the heat treatment time was 75 minutes, the difference in the total concentration of the oxidizing agents between the result obtained by absorption spectroscopy and the result obtained by Raman spectroscopy performed before the heat treatment was large.

### Example 16

The total concentration of oxidizing agents in an evaluation solution was measured in the same manner as in Example 1, except that an electrolyte containing sulfuric acid at a concentration of 3.50 mol/l was prepared based on the above-described Formula (4) and used as the evaluation solution, that the measurement wavelength used in the absorption spectroscopy was changed as shown in the table and that the measurement cell length was changed to 0.05 mm. The results thereof are shown in Table 6 below.

### Example 17

The total concentration of oxidizing agents in an evaluation solution was measured in the same manner as in Example 1, except that the measurement wavelength used in the absorption spectroscopy was changed as shown in Table and the measurement cell length was changed to 0.05 mm. The results thereof are shown in Table 6 below.

### Example 18

The total concentration of oxidizing agents in an evaluation solution was measured in the same manner as in Example 1, except that the measurement wavelength used in the absorption spectroscopy was changed as shown in the table. The results thereof are shown in Table 6 below.

TABLE 5

| | | Ex- | Ex- | Ex- |
|---|---|---|---|---|
| | | ample | ample | ample |
| | | 16 | 17 | 18 |
| Electrolyte | Acid concentration (mol/l) | 7.00 | 14.24 | 14.24 |
| | Peroxodisulfuric acid | 0.55 | 0.23 | 0.23 |
| | concentration (mol/l) | | | |
| | Peroxomonosulfuric acid | 0.45 | 0.67 | 0.67 |
| | concentration (mol/l) | | | |
| | Hydrogen peroxide | 0.00 | 0.10 | 0.10 |
| | concentration (mol/l) | | | |
| | Total concentration of | 1.00 | 1.00 | 1.00 |
| | oxidizing agents (mol/l) | | | |
| Heat treatment | Time between | 10 | 10 | 10 |
| step | preparation of electrolyte | | | |
| | and heat treatment (min) | | | |
| | Heat treatment | 105 | 105 | 105 |
| | temperature (° C.) | | | |
| | Heat treatment time (min) | 20 | 20 | 20 |
| Hydrogen | Measurement wavelength | 190.0 | 190.0 | 300.0 |
| peroxide | (nm) | | | |
| detection step | | | | |
| (absorption | | | | |
| spectroscopy) | | | | |

TABLE 6

| | | Example | Example | Example |
|---|---|---|---|---|
| | | 16 | 17 | 18 |
| Results | Total concentration of | 1.00 | 1.01 | 1.00 |
| obtained by | oxidizing agents after | | | |
| Raman | heat treatment (mol/l) | | | |
| spectroscopy | Ratio of hydrogen | 65 | 90 | 90 |
| | peroxide after heat | | | |
| | treatment (%) | | | |
| | Change in the total | 0 | 1 | 0 |
| | concentration of | | | |
| | oxidizing agents | | | |
| | before and after | | | |
| | heat treatment (%) | | | |
| Results | Absorbance | 0.928 | 1.172 | 0.022 |
| obtained by | Total concentration of | 0.80 | 1.01 | 1.01 |
| absorption | oxidizing agents after | | | |
| spectroscopy | heat treatment (mol/l) | | | |
| | Reproducibility | ∘ | ∘ | Δ |

| | | | |
|---|---|---|---|
| (Total concentration determined by | −20 | 1 | 1 |
| absorption spectroscopy − Total | | | |
| concentration before heat treatment)/ | | | |
| Total concentration before heat | | | |
| treatment × 100 (%) | | | |

From Examples 16 and 17, it was found that, when the measurement wavelength was 190 nm, even in those solutions whose total concentrations of the oxidizing agents were determined to be the same by Raman spectroscopy, the total concentrations of the oxidizing agents of the respective solutions were determined to be different by absorption spectroscopy due to the difference in the sulfuric acid concentration. The reason for this difference in the measurement results is believed to be because sulfuric acid absorbs a light having a wavelength of 190 nm and the absorbance of sulfuric acid was consequently different in the evaluation solutions having different sulfuric acid concentrations. Further, the reproducibility was found to be rather low. This is believed to be because, since the absorbance of hydrogen peroxide is high at a measurement wavelength of 190 nm, a very short cell of 0.05 in length was employed and this reduced the cell accuracy.

According to Example 18, when the measurement wavelength was 300 nm, the absorbance was low. As a result, the reproducibility was low.

### Example 19

The evaluations were performed using a controlled-potential method as the hydrogen peroxide detection method. The evaluation solution was the same as the one used in Example 1. As the material of the working electrode, conductive diamond was employed, and the holding potential of the working electrode was set at 2.4 V to record the current at 30 seconds after the start of the measurement. The results thereof are shown in Table 8 below.

### Example 20

The total concentration of oxidizing agents in an evaluation solution was measured in the same manner as in Example 19, except that the holding potential of the working electrode used in the controlled-potential method was changed to 3.2 V. The results thereof are shown in Table 8 below.

### Example 21

The total concentration of oxidizing agents in an evaluation solution was measured in the same manner as in Example 19, except that the material of the working electrode used in the controlled-potential method was changed to a glassy carbon (GC) and that the holding potential of the working electrode was changed to 1.5 V. The results thereof are shown in Table 8 below.

### Example 22

The total concentration of oxidizing agents in an evaluation solution was measured in the same manner as in Example 19, except that the material of the working electrode used in the controlled-potential method was changed to platinum and that the holding potential of the working electrode was changed to 0.4 V. The results thereof are shown in Table 8 below.

TABLE 7

| | | Example | Example | Example | Example |
|---|---|---|---|---|---|
| | | 19 | 20 | 21 | 22 |
| Electrolyte | Acid concentration | 14.24 | 14.24 | 14.24 | 14.24 |
| | (mol/l) | | | | |
| | Peroxodisulfuric acid | 0.23 | 0.23 | 0.23 | 0.23 |
| | concentration (mol/l) | | | | |
| | Peroxomonosulfuric acid | 0.67 | 0.67 | 0.67 | 0.67 |
| | concentration (mol/l) | | | | |
| | Hydrogen peroxide | 0.10 | 0.10 | 0.10 | 0.10 |
| | concentration (mol/l) | | | | |
| | Total concentration of | 1.00 | 1.00 | 1.00 | 1.00 |
| | oxidizing agents (mol/l) | | | | |
| Heat treatment | Time between | 10 | 10 | 10 | 10 |
| step | preparation of electrolyte | | | | |
| | and heat treatment (min) | | | | |
| | Heat treatment | 105 | 105 | 105 | 105 |
| | temperature (° C.) | | | | |
| | Heat treatment time (min) | 20 | 20 | 20 | 20 |
| Hydrogen | Working electrode | Conductive | Conductive | GC | Platinum |
| peroxide | material | diamond | diamond | | |
| detection step | Working electrode | 2.4 | 3.2 | 1.5 | 0.4 |
| (controlled- | potential (Vvs.SHE) | | | | |
| potential | | | | | |
| method) | | | | | |

TABLE 8

| | | Example | Example | Example | Example |
|---|---|---|---|---|---|
| | | 19 | 20 | 21 | 22 |
| Results | Total concentration of | 0.99 | 0.99 | 0.99 | 0.99 |
| obtained by | oxidizing agents after heat | | | | |
| Raman | treatment (mol/l) | | | | |
| spectroscopy | Ratio of hydrogen | 90 | 90 | 90 | 90 |
| | peroxide after heat | | | | |
| | treatment (%) | | | | |
| | Change in the total | −1 | −1 | −1 | −1 |
| | concentration of oxidizing | | | | |
| | agents before and after | | | | |
| | heat treatment (%) | | | | |
| Results | Current (μA) | 27 | 150 | 35 | 400 |
| obtained by | Total concentration of | 0.93 | 2.46 | 1.06 | 1.04 |
| controlled- | oxidizing agents after heat | | | | |
| potential | treatment (mol/l) | | | | |
| method | Reproducibility | | ∘ | | |

| | | | | |
|---|---|---|---|---|
| (Total concentration determined by | −7 | 146 | 6 | 4 |
| controlled-potential method − Total | | | | |
| concentration before heat treatment)/ | | | | |
| Total concentration before heat | | | | |
| treatment × 100 (%) | | | | |

In Example 19, the current was 27 μA and the concentration was calculated from this current to be 0.93 mol/l. The difference in the values of the total concentration of the oxidizing agents that were measured by Raman spectroscopy and absorption spectroscopy was small, meaning that the measurement accuracy was high. Further, the reproducibility was evaluated to be high, with the current values measured in the second and the third measurements being 28 μA and 27 μA, respectively. Therefore, good measurement accuracy and reproducibility were attained.

In Example 20, the current was 150 μA and the concentration was calculated from this current to be 2.46 mol/l. The difference in the values of the total concentration of the oxidizing agents that were measured by Raman spectroscopy and the controlled-potential method was large, meaning that the measurement accuracy was low. This is believed to be because oxidation reaction of water proceeded simultaneously with oxidation of hydrogen peroxide.

In Example 21, the current was 35 μA and the concentration was calculated from this current to be 1.06 mol/l. The difference in the values of the total concentration of the oxidizing agents that were measured by Raman spectroscopy and the controlled-potential method was small, meaning that the measurement accuracy was high.

In Example 22, the current was 400 μA and the concentration was calculated from this current to be 1.04 mol/l. The difference in the values of the total concentration of the oxidizing agents that were measured by Raman spectroscopy and the electrochemical process was small, meaning that the measurement accuracy was high.

### Comparative Examples 1 to 3

As Comparative Examples 1 to 3, the total concentration of oxidizing agents in an evaluation solution was measured in the same manner as in Example 1, except that an electrolyte containing sulfuric acid at a concentration of 3.5 or 9.17 mol/l was prepared based on the above-described Formula (4) and that the acid concentration, heat treatment temperature and heat treatment time of the respective evaluation solutions were changed as shown in the table. The results thereof are shown in Table 10 below.

TABLE 9

| | | Comparative | Comparative | Comparative |
|---|---|---|---|---|
| | | Example 1 | Example 2 | Example 3 |
| Electrolyte | Acid concentration (mol/l) | 7.00 | 7.00 | 18.34 |
| | Peroxodisulfuric acid | 0.55 | 0.55 | 0.35 |
| | concentration (mol/l) | | | |
| | Peroxomonosulfuric acid | 0.45 | 0.45 | 0.55 |
| | concentration (mol/l) | | | |
| | Hydrogen peroxide | 0.00 | 0.00 | 0.10 |
| | concentration (mol/l) | | | |
| | Total concentration of | 1.00 | 1.00 | 1.00 |
| | oxidizing agents (mol/l) | | | |
| Heat treatment step | Time between preparation | 10 | 10 | 10 |
| | of electrolyte and heat | | | |
| | treatment (min) | | | |
| | Heat treatment temperature | 40 | 40 | 140 |
| | (° C.) | | | |
| | Heat treatment time (min) | 20 | 100 | 20 |

| | | |
|---|---|---|
| Hydrogen peroxide | Measurement wavelength | 253.7 |
| detection step | (nm) | |
| (absorption | | |
| spectroscopy) | | |

TABLE 10

| | | Comparative | Comparative | Comparative |
|---|---|---|---|---|
| | | Example 1 | Example 2 | Example 3 |
| Results obtained | Total concentration of oxidizing | 1.00 | 1.00 | 0.51 |
| by Raman | agents after heat treatment (mol/l) | | | |
| spectroscopy | Ratio of hydrogen peroxide after | 20 | 57 | 90 |
| | heat treatment (%) | | | |
| | Change in the total concentration of | 0 | 0 | −49 |
| | oxidizing agents before and after | | | |
| | heat treatment (%) | | | |
| Results obtained | Absorbance | 0.173 | 0.208 | 0.177 |
| by absorption | Total concentration of oxidizing | 0.50 | 0.60 | 0.51 |
| spectroscopy | agents after heat treatment (mol/l) | | | |
| | Reproducibility | ∘ | ∘ | ∘ |

| | | | |
|---|---|---|---|
| (Total concentration determined by absorption | −50 | −40 | −49 |
| spectroscopy − Total concentration before heat treatment)/ | | | |
| Total concentration before heat treatment × 100 (%) | | | |

From the results of Comparative Examples 1 and 2, it was found that the ratio of hydrogen peroxide after the heat treatment was low when the heat treatment temperature was 40° C. This is believed to be because the heat treatment was not sufficient and the reactions of the above-described Formulae (1) and (2), therefore, did not proceed sufficiently. Consequently, the difference in the total concentration of the oxidizing agents between the result obtained by absorption spectroscopy and the result obtained by Raman spectroscopy performed before the heat treatment was large.

From Comparative Examples 3, it was found that the change in the oxidizing agent concentration before and after the heat treatment was large when the heat treatment temperature was 140° C. This is believed to be attributable to the progress of the reaction of the above-described Formula (3). Consequently, the difference in the total concentration of the oxidizing agents between the result obtained by absorption spectroscopy and the result obtained by Raman spectroscopy performed before the heat treatment was large.

From the results of Comparative Examples 1 to 3, it was found the method of measuring the total concentration of oxidizing agents is not usable with heat treatment temperature of 40° C. or 140° C.

### INDUSTRIAL APPLICABILITY

The present invention is useful as a method of measuring the total concentration of oxidizing agents in an evaluation solution which contains multiple components of oxidizing agents, such as peroxodisulfate ion, peroxomonosulfate ion and hydrogen peroxide, at a high concentration.

1. A method of measuring the total concentration of oxidizing agent(s) in an evaluation solution containing at least one oxidizing agent, said method being characterized by comprising at least the steps of:
heat-treating said evaluation solution at 50 to 135° C. (heat treatment step); and
detecting hydrogen peroxide in the thus heat-treated evaluation solution (hydrogen peroxide detection step).

2. The method according to claim 1, wherein said evaluation solution comprises, as said oxidizing agent, at least one of peroxodisulfate ion, peroxomonosulfate ion and hydrogen peroxide.

3. The method according to claim 1, wherein said evaluation solution has an acid concentration of 6 to 24 mol/l.

4. The method according to claim 1, wherein said heat treatment in said heat treatment step is performed for 2 to 70 minutes after the temperature of said evaluation solution reached a prescribed temperature.

5. The method according to claim 1, wherein hydrogen peroxide is detected in said hydrogen peroxide detection step by using any one selected from absorbance, electrochemical process, ultrasonic wave, density and refractive index.

6. The method according to claim 5, wherein detection of hydrogen peroxide in said hydrogen peroxide detection step is performed by measuring the absorbance at a wavelength of 220 to 290 nm.

7. The method according to claim 5, wherein detection of hydrogen peroxide in said hydrogen peroxide detection step is performed by an electrochemical process using a carbon material or platinum as a working electrode.

8. The method according to claim 5, wherein detection of hydrogen peroxide in said hydrogen peroxide detection step is performed by said electrochemical process and, in said electrochemical process, said working electrode is retained at an electric potential at which electrolysis reaction of water does not proceed and only oxidation or reduction reaction of hydrogen peroxide proceeds.

9. A concentration meter for measuring the total concentration of oxidizing agents, which is used to measure the total concentration of oxidizing agent(s) in an evaluation solution containing at least one oxidizing agent, said concentration meter being characterized by comprising:
a storage section where said evaluation solution is stored;
a heat treatment section where said evaluation solution in said storage section is heated to a prescribed temperature; and
a hydrogen peroxide detecting section where hydrogen peroxide in the thus heat-treated evaluation solution is detected.

10. The concentration meter according to claim 9, wherein said hydrogen peroxide detecting section comprises any one selected from an absorbance meter, an electrochemical measuring instrument, an ultrasonic meter, a densimeter and a refractometer.

11. The concentration meter according to claim 10, wherein said hydrogen peroxide detecting section comprises an absorbance meter equipped with a light source having an emission wavelength of 220 to 290 nm.

12. The concentration meter according to claim 10, wherein said hydrogen peroxide detecting section comprises an electrochemical measuring instrument in which a carbon material or platinum is used as a working electrode.

13. The concentration meter according to claim 10, wherein said hydrogen peroxide detecting section comprises said electrochemical measuring instrument and said working electrode used therein is retained at an electric potential at which electrolysis reaction of water does not proceed and only oxidation or reduction reaction of hydrogen peroxide proceeds.

14. A sulfuric acid electrolysis device, characterized by comprising the concentration meter for measuring the total concentration of oxidizing agents according to claim 9.

15. A sulfuric acid electrolysis device, characterized by comprising the concentration meter for measuring the total concentration of oxidizing agents according to claim 10.

16. A sulfuric acid electrolysis device, characterized by comprising the concentration meter for measuring the total concentration of oxidizing agents according to claim 11.

17. A sulfuric acid electrolysis device, characterized by comprising the concentration meter for measuring the total concentration of oxidizing agents according to claim 12.

18. A sulfuric acid electrolysis device, characterized by comprising the concentration meter for measuring the total concentration of oxidizing agents according to claim 13.
